(19) United States
(12) Patent Application Publication
(10) Pub. No.: US 2013/0325405 A1
(43) Pub. Date: Dec. 5, 2013

(54) Modular Alternator and Starter Tester with a Four Link Hood Hinge

(71) Applicants: Garret Miller, Owatonna, MN (US); Lee Jardine, Owatonna, MN (US); John Kleifgen, Apple Valley, MN (US); Chad Samp, Albert Lea, MN (US); Eric VandeZande, Owatonna, MN (US)

(72) Inventors: Garret Miller, Owatonna, MN (US); Lee Jardine, Owatonna, MN (US); John Kleifgen, Apple Valley, MN (US); Chad Samp, Albert Lea, MN (US); Eric VandeZande, Owatonna, MN (US)

(73) Assignee: Service Solutions U.S. LLC, Wilmington, DE (US)

(21) Appl. No.: 13/483,515

(22) Filed: May 30, 2012

(51) Int. Cl. G06F 15/00

(52) U.S. Cl. 702/183

(57) ABSTRACT

A diagnostic tool for testing the performance of a component of a vehicle may include a processor configured to process test information from an alternator of the vehicle and control and activate the alternator of the vehicle having identification information to be tested. The diagnostic tool may also include a memory configured to store the test information of the alternator and software that operates the alternator of the vehicle. The diagnostic tool may further comprise a removable modular component comprising an operational circuitry that allows for the diagnostic tool to operate, wherein the removable modular component is replaced based at least in part on a determination that the operational circuitry is faulty, wherein the memory and the removable modular component are in communication with the processor.

### FIELD OF THE DISCLOSURE

The present invention pertains to the field of testing vehicle motor rotary accessory devices. More particularly, the present invention relates to modular devices for testing alternators or starter motors and the like.

### BACKGROUND OF THE DISCLOSURE

It is well known in the automotive industry that certain rotary diagnostic devices are often used in connection with the diagnosis of components of vehicle motors. Two such vehicle components are alternators and starter motors. Alternators are used in connection with an engine and are typically belt driven by the engine. Alternators have internal components, which when rotated supply electrical power to a vehicle and/or an engine. Alternators are typically removable but rigidly mounted via a bracket to the engine block or the chassis of the vehicle. In many cases, a standard mounting arrangement is used, wherein the alternator has “ears” with holes that are mounted onto a post or bolt attached to the vehicle. This mounting arrangement permits pivoting of the alternator so that the alternator can be rotated around the post against the belt tension in order to install and remove belts, and provide a suitable tension when the belt is installed.

Starter motors are electrical motors, which are typically rigidly mounted to an engine or transmission casing. The starter motor has an electrically driven pinion gear extending from the starter motor that engages a component (typically gears on the flywheel of the engine) in order to rotate the crankshaft of the engine to start it. There is a wide range of attachment mechanisms for attaching said starter motor.

When testing an alternator, it is desirable to attach to a belt to a pulley of the alternator and drive the belt with a drive motor. This situation requires both, a way to securely but removably mount the alternator, and a way to provide belt tensioning. Also, when testing a starter motor, it is desirable to have a transformer that may provide electrical power to the starter motor in order to simulate operating environments. The transformer may be powered by an external power source and may provide test power to the starter motor via a heavy duty cable and heavy duty clamps. Accordingly, it is desirable to have an apparatus and method that is able to conveniently mount the alternator and/or the starter motor to the overall testing apparatus so that it can be quickly, conveniently, safely, and easily engaged and disengaged from the testing apparatus. Also, it is desirable for an apparatus to have components that may be easily removed and replaced.

### SUMMARY OF THE DISCLOSURE

The foregoing needs are met, to a great extent, by the present disclosure, wherein in one aspect, a diagnostic tool and a method for testing are provided that in some embodiments an alternator and starter motor tester includes a four link hood and a plurality of modular components.

In an exemplary embodiment, the diagnostic tool for testing a performance of a component of a vehicle may include a processor configured to process test information from an alternator of the vehicle and control and activate the alternator of the vehicle having identification information to be tested. The diagnostic tool may also include a memory configured to store the test information of the alternator and software that operates the diagnostic tool. The diagnostic tool may further comprise a removable modular component comprising an operational circuitry that allows for the diagnostic tool to operate, wherein the removable modular component is replaced based on a determination that the operational circuitry is faulty, wherein the memory and the removable modular component are in communication with the processor.

In another exemplary embodiment, the diagnostic tool for testing a performance of a component of a vehicle may include a processor configured to process test information from a starter motor of the vehicle and control and activate the starter motor of the vehicle having identification information to be tested. The diagnostic tool may also include a memory configured to store the test information of the starter motor and software that operates the diagnostic tool. The diagnostic tool may further include a removable modular component comprising an operational circuitry that allows for the diagnostic tool to operate, wherein the removable modular component is replaced based on a determination that the operational circuitry is faulty, wherein the memory and the removable modular component are in communication with the processor.

In an exemplary embodiment, the method of testing of a component of a vehicle may include the steps of activating, via a processor of a diagnostic tool, an alternator to generate test information and processing, via the processor of the diagnostic tool, the test information from the alternator of the vehicle. The method may also include the steps of receiving the test information associated with the alternator of the vehicle via test leads and performing, via the processor of the diagnostic tool, a diagnostic test on the alternator. The method may further include the step of determining, via the processor of the diagnostic tool, whether a removable module component that comprises an operation circuitry is faulty and needs to be replaced based on a determination that the removable module component is faulty.

In another exemplary embodiment, the method of testing of a component of a vehicle may include the steps of activating, via a processor of a diagnostic tool, a starter motor to generate test information and processing, via the processor of the diagnostic tool, the test information from the starter motor of the vehicle. The method may also include the steps of receiving the test information associated with the starter motor of the vehicle via test leads and performing, via the processor of the diagnostic tool, a diagnostic test on the starter motor. The method may further include the step of determining, via the processor of the diagnostic tool, whether a removable module component that comprises an operation circuitry is faulty and needs to be replaced based on a determination that the removable module component is faulty.

In an exemplary embodiment, the diagnostic tool for testing the performance of a component of a vehicle may include means for processing test information from an alternator or a starter motor of the vehicle and control and activate the alternator or the starter motor of the vehicle having identification information to be tested. The diagnostic tool may also include means for storing the test information of the alternator or the starter motor and software that operates the diagnostic tool. The diagnostic tool may further include a removable modular component comprising an operational circuitry that allows for the diagnostic tool to operate, wherein the removable modular component is replaced based at least in part on a determination that the operational circuitry is faulty, wherein the removable modular component and the means for removing are in communication with the means for processing.

There has thus been outlined, rather broadly, certain embodiments of the disclosure in order that the detailed description herein may be better understood, and in order that the present contribution to the art may be better appreciated. There are, of course, additional embodiments of the present disclosure that will be described below and which will form the subject matter of the claims appended hereto.

In this respect, before explaining at least one embodiment of the present disclosure in detail, it is to be understood that the present disclosure is not limited in its application to the details of construction and to the arrangements of the components set forth in the following description or illustrated in the drawings. The present disclosure is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 is a perspective view of an alternator and starter motor tester according to an embodiment of the present invention.

FIG. 2 is a perspective view of the alternator and starter motor tester according to another exemplary embodiment of the present invention.

FIG. 3 is a block diagram of the hardware components of the alternator and starter motor tester according to an exemplary embodiment of the present invention.

FIG. 4 illustrates a perspective view of an alternator and starter motor tester having modular components according to an exemplary embodiment of the present invention.

FIG. 5 is a perspective view of the peripheral and remote connections of the tester illustrated in FIG. 1 in accordance with an embodiment of the present invention.

FIGS. 6A-D illustrate an alternator and starter motor starter having a hood according to an exemplary embodiment of the present invention.

### DETAILED DESCRIPTION OF EMBODIMENTS

The present disclosure will now be described with reference to the drawing figures, in which like reference numerals refer to like parts throughout. An embodiment in accordance with the present disclosure provides an alternator and starter tester for holding and testing an alternator or starter motor that includes a protective hood or cover, a controller connecting an LCD touch-screen, a barcode connector, USB host and USB function connectors, an Ethernet connector, and a flash memory connector.

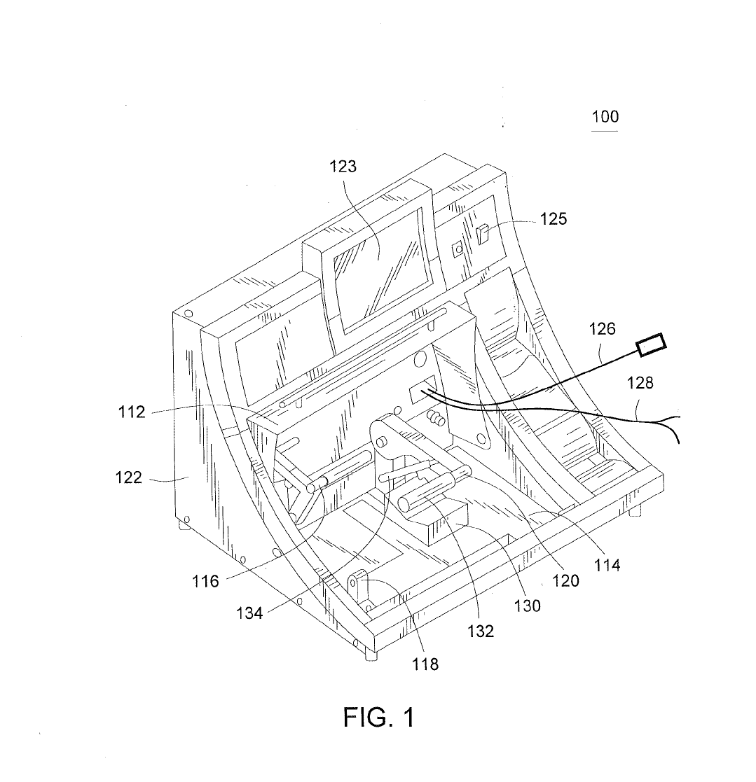

An embodiment of the present testing apparatus is illustrated in FIG. 1. FIG. 1 illustrates an alternator and starter motor tester 100 (“tester”) including a housing 112 and a base plate (or chassis) 114. The housing 112 surrounds and supports various operative components of the tester 100 including, for example, a power supply, diagnostic electronics, mounting devices, a monitor screen 123, a protective door cover 122, and the like. In one embodiment, the monitor screen 123, e.g., LCD touch-screen, may be disposed within the housing 112. A test power button 125, such as a toggle-switch, is provided on the housing 112 to activate and de-activate the test power to the driver motor (not shown) and/or the transformer (not shown). A main power switch (not shown) is also used to provide power to the tester 100.

The tester 100 also includes an alternator belt tensioning arrangement generally designated 116, an alternator mounting arrangement generally designated 118, and a starter motor holder arrangement generally designated as 120. Each of the belt tensioning arrangement 116, the alternator mounting arrangement 118, and the starter motor holder arrangement 120 are mounted directly to the base plate 114.

The alternator belt tensioning arrangement 116 and the mounting arrangement 118 together hold the alternator in place for testing. An installation assembly that includes one or more mounting pins (not shown) can be placed in the mounting arrangement 118 in order to mount the alternator. The alternator can be horizontally or vertically mounted depending on the type of alternator. The pins are replaceable to allow flexibility for current and future applications.

Also shown in FIG. 1, a test adapter 126 and power leads 128 can be connected to the alternator or starter motor in order to provide test information to tester 100. Additionally, a drive belt (not shown), such as a serpentine or V belt or the like, can be connected to the alternator and the drive motor to simulate the operating environment in the vehicle. A gas piston may be used for belt tension to ensure consistent belt tension during testing, thereby eliminating over tensioning or belt slippage that may affect test results.

The starter motor holder arrangement 120 includes a quick release ratchet system, wherein the starter is placed on a pad and held in place by the ratchet system. The starter motor holder arrangement 120 includes, a support pad 130, a handle 132 and a release lock 134 that when operated engages and disengages a lock (pawl, for example) from a ratchet (both not shown). The starter motor holder arrangement 120 helps to eliminate the use of straps, and alternatively uses the quick ratchet to hold the starter without the need of any additional holding mechanism or end user assistance during the test. Thus, the aforementioned arrangement makes the loading and unloading of components to be tested much more efficient. The starter motor may be placed on the support pad 130 for testing. Upon the placement, the operator squeezes the release lock and presses down on the handle 132 to engage the starter motor and then releases the lock so that the lock is again reengaged. The starter motor may be powered by a transformer (not shown) in order to simulate operating environments. The transformer may be powered by an external power source and may provide test power to the starter motor via a heavy duty cable and clamps. Power leads 128, including, for example, battery lead, ground lead, solenoid lead and sense lead are connected to the starter motor in order to conduct the tests.

FIG. 1 also illustrates the monitor screen 123 that can operate as a touch-screen LCD user interface that communicates with a controller (discussed below) as well as to display information to the end user. The present disclosure also utilizes an on-line tutorial for quickly training new personnel on the unit's functionality and on-line help screens to help new users navigate and test components during a test. The monitor screen 123 may offer step-by-step instructions for setting up the tester 100 and conducting tests. The monitor screen 123 may also display on-screen hook up diagrams and a specification library database, which eliminate the need for paper flipcharts and enables software updates for new alternator applications or starter configurations. This database can be updated by compact flash, flash drive, other memory media or remotely via a network connection (discussed below). The monitor screen 123 may allow end users to run advertising screens when the tester is not in use. These screens can be uploaded to the tester 100 from an end user's network server or uploaded from a compact flash or other memory media. Additionally, the monitor screen 123 may be capable of displaying information in various updatable languages.

The tester 100 may output “Good/Bad” or “Pass/Fail” results to the end user. An end user printout that details test results and provides technical advice for other potential problems can be provided to the end user.

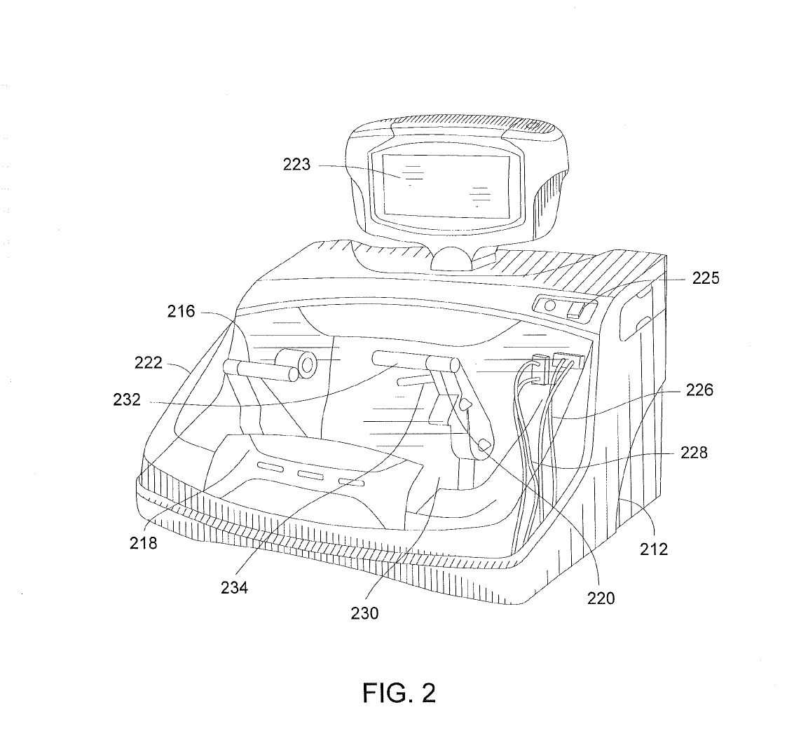

Turning now to FIG. 2, a perspective view of the alternator and starter motor tester 200 according to another exemplary embodiment of the present disclosure is illustrated. The alternator and starter motor tester 200 (“tester”) has components similar to the tester 100 depicted in FIG. 1, however it has an alternative design. For example, tester 200 includes a housing 212 and a base plate (or chassis) 214. The housing 212 surrounds and supports various operative components of the tester 200 including, for example, a power supply, diagnostic electronics, mounting devices, a monitor screen 223, a protective door cover 222, and the like. In the embodiment depicted, the monitor screen 223, is an LCD touch-screen disposed within the housing 212. A power button 225, such as a toggle-switch design, is provided on the housing 212 to activate or deactivate test power to the drive motor (not shown) and/or the transformer (not shown). A main power switch (not shown) is also used to provide power to the tester 200.

The tester 200 also includes an alternator belt tensioning arrangement generally designated 216, an alternator mounting arrangement generally designated 218, and a starter motor holder arrangement generally designated as 220. Each of the belt tensioning arrangement 216, the alternator mounting arrangement 218, and the starter motor holder arrangement 220 are mounted directly to the base plate 214.

The test adapters 126 and power leads 128 may be connected to the alternator or starter motor in order to provide test information to tester 200. Additionally, a drive belt (not shown), such as a serpentine or V belt or the like, can be connected to the alternator, the drive motor to simulate the operating environment in the vehicle. A gas piston may be used for belt tension to ensure consistent belt tension during testing and thereby eliminating over tensioning or slipping belts that may affect test results.

The starter motor holder arrangement 220 includes a quick release ratchet system, wherein the starter is placed on a pad and held in place by the ratchet system. The starter motor holder arrangement 220 includes, a support pad 230, a handle 232 and a release lock 234 that when operated engages and disengages a lock (pawl, for example) from a ratchet (both not shown). The starter motor holder arrangement 220 helps to eliminate the use of straps, and alternatively uses the quick ratchet to hold the starter without the need of any additional holding mechanism or end user assistance during the test. Thus, the aforementioned arrangement makes the loading and unloading of components to be tested much more efficient. The starter motor may be placed on the support pad 230 for testing. Upon the arrangement, the operator squeezes the release lock and presses down on the handle 232 to engage the starter motor and then releases the lock so that the lock is again reengaged. Power leads 228, including, for example, battery lead, ground lead, solenoid lead and sense lead are connected to the starter motor in order to conduct the tests.

In the embodiment depicted in FIG. 2, the tester 200 may incorporate enhanced safety features, such as the protective door cover 222 to enclose moving parts during tests. The protective door cover 222 conceals the belt tensioning arrangement 216, the alternator mounting arrangement 218, the starter motor holder arrangement 220, and other test components, such as an alternator or starter motor. The protective door cover 222 of the tester 200 is shown covering at least the belt tensioning arrangement 216, the alternator mounting arrangement 218, and the starter motor holder arrangement 220 in the closed position.

In the closed position, the protective door cover 222 eliminates the possibility of hands getting caught in moving parts or projectiles potentially contacting the end user. The protective door cover 222 may employ a door interlock switch (not shown) to disable tests while the protective door cover 222 is open. Alternatively, the protective door cover 222 may include a viewing window so that the operator can observe the testing components during the tests.

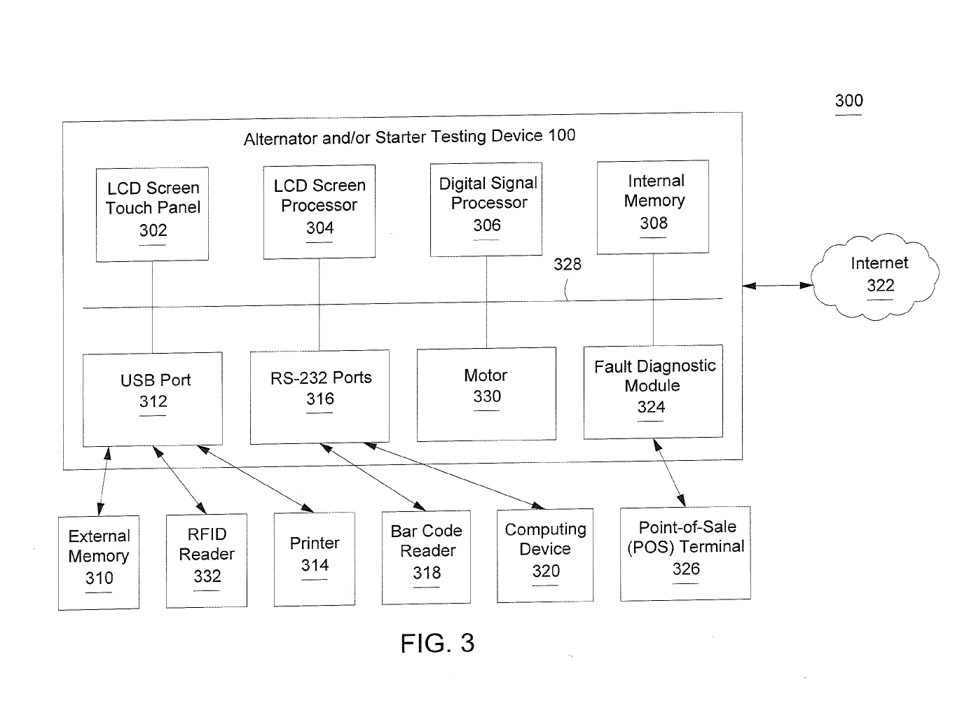

FIG. 3 is a block diagram 300 of the components of the alternator and starter motor tester as previously described and shown in FIGS. 1-2 according to an exemplary embodiment of the present invention. The components generally include a monitor screen, such as LCD screen 302 that various information to the user. The LCD screen 302 may be a touch panel to input information as desired by the user and can be controlled by a processor 304. The processor 304 may be any processor or controller, including a FPGA (Field Programmable Gate Array). The processor 304 is capable and runs various OS (Operating System) including Linux, Apple Computer's Operating System (such as OS X), Windows, Windows CE and the like. The processor 304 communicates with a digital signal processor 306, which includes an analog and digital (A/D) converter. The processor 304 communicates with other components (e.g., internal memory 308, USB port 312, RS-232 ports 316, motor 330, interface module 324 and/or diagnostic trouble code (DTC) interpreter 338) of the tester 100 via a communication bus 328.

The processor 304 is configured to communicate with an internal memory 308 and an external memory 310. The internal memory 308 and/or the external memory 310 can be any memory including, for example, compact flash, SD (secure digital), USB flash drives, and the like. A universal serial bus (USB) port 312 communicates with the processor 304 and provides a connection for various USB compatible devices, such as, for example, an external memory 310, a printer 314, a radio frequency identification (RFID) reader 332 and/or a diagnostic tool 336. The RFID reader 332 functions to read identifying information about the tested component containing an RFID chip once it is within a detection range. The RFID chip may contain information about the alternator or starter motor such as alternator/starter motor type, serial number, manufacturer, date of production or shipment, previous test results, electrical specifications, maintenance information, serial number, lot number, warranty information, a manufacture data code, method of shipment and the like.

RS-232 ports 316 also communicate with other external devices, such as a computing device 320, a bar code reader 318 and/or the diagnostic tool 336. The computing device 320 can be any computing device, including a personal computer, a laptop, a personal digital assistant (PDA), a cell phone or the like.

The bar code reader 318 allows the user to scan bar code information that may be attached to the tested component or the VIN (vehicle identification number) of the vehicle from which the tested component came from. The bar code reader 318 may be, for example, a conventional optical bar code reader, such as a gun or wand type reader.

During operation, end user swipes or aims the bar code reader 318 over the bar code that is associated with the particular alternator or starter motor to be tested and reads the bar code accordingly. The bar code itself may be affixed to the alternator or starter motor at the time of manufacture, purchase, shipment or service. The bar code may contain information, or point to information stored in a database. The database may be local or remotely located and accessible by the Internet, Ethernet, Wi-Fi, LAN, Bluetooth or other wireless or a wired connection.

The bar code may provide a variety of information regarding the alternator or starter motor to be tested. For example, the bar code may provide information regarding the alternator/starter motor type, serial number, manufacturer, date of production or shipment, previous test results, electrical specifications, maintenance information, serial number, lot number, warranty information, a manufacture data code, method of shipment and the like. This data can be used to select parameters for the test cycle run to test the alternator and starter motor. The data provided by the bar code is not limited to the examples given.

In some embodiments, the printer 314 may print bar code labels that may be attached or otherwise associated with the alternator or starter motor and provides updated information about the component. The updated information may include, among other things, service dates, service procedures (including the results), and warranty information (e.g., time left on warranty, who was the original purchaser, what types of service are and are not warranted, etc.), other possible causes of problem when the alternator and starter motor pass the test, and other diagnostic procedures when the alternator and starter motor pass the test. The printed label may then be read by the bar code reader 318 in subsequent tests. These features can eliminate possible typographical errors during manual input and by speeding up part number selection and entry by having a scanning capability.

The present invention also has the ability to store and display or print technical service bulletins associated with specific part numbers of the components to be tested. Printouts of test results can give technicians access to data obtained by users to assist in the further analysis of that component.

The processor 304 can also communicate with a fault diagnostic module 324. The fault diagnostic module 324 may communicate with other external devices, such as a point-of-sale (POS) terminal 326. The fault diagnostic module 324 by itself or in combination with the processor 304 may automatically perform diagnostic test to determine faulty components of the tester 100. For example, the fault diagnostic module 324 may automatically perform periodic (e.g., daily, weekly, monthly, quarterly, yearly) diagnostic test on the tester 100 in order to determine faulty components of the tester 100. In another exemplary embodiment, the fault diagnostic module 324 may perform diagnostic test on the tester 100 based at least in part on a user request.

The fault diagnostic module 324 may display the test results/fault information to the user via the LCD screen 302. Also, the fault diagnostic module 324 may provide the test result/fault information (e.g., the fault components that may be replaced) to the user via the point-of-sale (POS) terminal 326. Subsequently or simultaneously, the point-of-sale (POS) terminal 326 may provide the faulty information to the supplier or the manufacturer of the tester 100, as further discussed herein. In another exemplary embodiment, the fault diagnostic module 324 may directly provide the test result/fault information to the supplier or the manufacturer of the tester 100. The test result/fault information may assist the user to replace the corresponding faulty components of the tester 100 without having to ship the tester 100 back to the supplier or manufacturer for repair. Also, the test result/fault information may assist the supplier or manufacturer to track faulty components of the tester 100. By tracking the faulty components of the tester 100, the supplier or manufacturer may identify top reported faulty components and update the diagnostic test performed by the fault diagnostic module 324.

The top reported fixes may include most frequently reported fixes associated with a diagnostic code. For example, the most frequently reported fix associated with an alternator may be a broken engine belt. The most frequently reported fix for a starter motor may be a damaged wire. The tester 100 may determine that the alternator and the starter motor are functioning properly and may provide the top reported fixes to the user in order to assist the user to determine a problem of the vehicle.

The fault diagnostic module 324 may comprise a database (or access the internal memory 308 or the external memory 310 that stores the database) for storing information associated with the tested tester 100 and information associated with the diagnostic test performed by the fault diagnostic module 324. The information associated with the tester 100 may include, but not limited to, tester type, serial number, manufacturer, date of production or shipment, previous diagnostic test results, electrical specifications, maintenance information, serial number, lot number, warranty information, a manufacture data code, method of shipment and the like. The information associated with the diagnostic test performed by the fault diagnostic module 324 may include, but not limited to, test specification, test values, test results (including previous test results), data, time, employee, location, weather condition during testing (extreme cold or heat that may affect the test) and/or any other information associated with the diagnostic test. The fault diagnostic module 324 may store the information or provide a summary report of fault diagnostic test result/fault information of the tester 100 and information associated with the diagnostic tests performed by the fault diagnostic module 324 for a period of time.

The fault diagnostic module 324 may provide the summary report comprising the information associated with the tester 100 and information associated with the diagnostic test to the point-of-sale (POS) terminal 326. For example, the fault diagnostic module 324 may encrypt the summary report transmitted to the point-of-sale (POS) terminal 326 or the supplier or manufacturer of the tester 100 in order to maintain the integrity of the transmitted information. The fault diagnostic module 324 may use various encryption algorithms to encrypt the transmitted information. For example, the encryption algorithms may include, but not limited to, tiny encryption algorithm (TEA), symmetric-key or asymmetric-key encryption algorithm, block encryption algorithm, steam encryption algorithm, public-key or private-key encryption algorithm, random number encryption algorithm, hash encryption algorithm, authentication code encryption algorithm or any other encryption algorithms. In another example, the fault diagnostic module 324 may transmit the summary report without encryption in order to save time and bandwidth.

Also, the fault diagnostic module 324 may include a database that may store repair procedures for various faulty components of the tester 100. The repair procedures may include information that may allow a user to repair the tester 100 without having to ship the tester 100 back to the supplier or manufacturer for repair. The fault diagnostic module 324 may provide the repair procedures to the user via the LCD-screen 302 or the point-of-sale (POS) terminal 326. In addition, the fault diagnostic module 324 may provide the summary report comprising the information associated with the tester 100, information associated with the diagnostic test to the printer 314 and/or repair procedures to external devices (e.g., printer 314 and/or the point-of-sale (POS) terminal 326). The printer 314 may print out the summary report for the user. The point-of-sale (POS) terminal 326 may display the summary report to the user.

The fault diagnostic module 324 may provide the summary report comprising the information associated with the tester 100 and information associated with the diagnostic test to the suppliers or manufacturers of the tester 100 via the Internet 322. The suppliers or manufactures may store the summary report and process the summary report. The suppliers or manufacturers of the tester 100 may identify faulty components in the summary report and possible repairs of the faulty components. The suppliers or manufacturers may arrange the faulty components of the tester 100 corresponding to the summary report. The suppliers or manufacturers may prioritize the faulty components based on received summary reports stored in a prior experience database. The prior experience database may have identified faulty components based on past diagnostics of various vehicular components, wherein the highest ranked faulty components may be the most reported by the summary reports to the prior experience database to report the diagnostic results. The supplier and manufacturer may map top repairs with the faulty components. The supplier and manufacturer may supply updated diagnostic procedures to the fault diagnostic module 324 in order to detect faulty components of the ester 100.

The fault diagnostic module 324 may receive an updated diagnostic procedure from the supplier or manufacturer of the tester 100. The updated diagnostic procedures may be based on the plurality of summary reports gather over a period of time. In an exemplary embodiment, the updated diagnostic procedures may include a procedure to diagnose the top reported faulty components first and diagnose the least reported faulty components last.

The processor 304 and the fault diagnostic module 324 may also interact with a networked computer, LAN (local area network), a smartphone, cellular phone or a distributed network, such as the Internet 322 and the like. This connection allows the user to update the tester 100 and also send information regarding the diagnostic test results to a remote location. The information sent or received may include, software, firmware, language and database for the components to be tested or to the tester 100.

A motor 330 is also provided in order to test alternators components. The motor 330 can simulate the engine of a vehicle and includes a pulley to mate with a belt. At one end, the belt is coupled to the motor's 330 pulley and at the other end it is coupled to the pulley of the alternator to be tested.

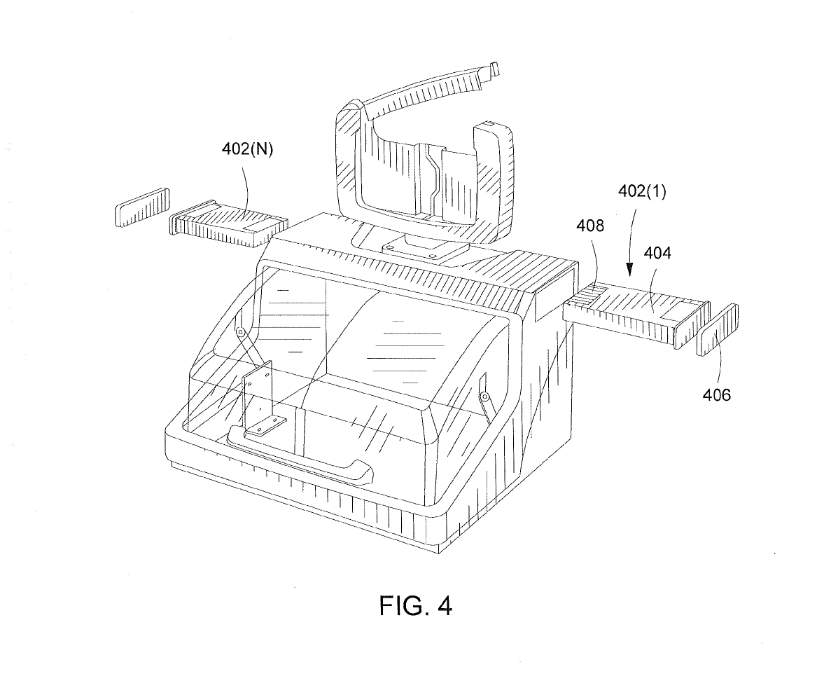

FIG. 4 illustrates an alternator and starter motor tester 400 having modular components according to an exemplary embodiment of the present disclosure. The alternator and starter motor tester 400 (“tester”) may include one or more modular components 402(1-N) that may be easily replaced by a user. Although two modular components 402 are illustrated in FIG. 4, one skilled in the art would appreciate that additional modular components 402 may be installed in the tester 400. In an exemplary embodiment, the modular components 402 may be installed on side portions of the tester 400. In other exemplary embodiments, the modular components 402 may be installed on other portions (e.g., back portion, base portion) of the tester 400. The modular components 402 may be easily taken out and may be replaced with a new modular component 402. Thus, the modular components 402 may enable a user to perform repair to the tester 400 without having to ship the tester 400 back to the suppliers or manufacturers for repair.

The modular components 402 may include an enclosure component 404 and a cover component 406 that may cover an opening of the enclosure component 404. The enclosure component 404 may include a plurality of pins 408 that may be electrically coupled to the tester 400. The plurality of pins 408 may provide power to the modular component 402 from the tester 400. Also, the plurality of pins 408 may provide communication and transmit electrical signals between the modular component 402 and the tester 400. The plurality of pins 408 may provide a ground connection for the modular component 402. For example, during a removal of the modular component 402 from the tester 400, the ground connection of the plurality of pins 408 may prevent an electrostatic shock to the user by grounding the electrostatic charges accumulated on the modular component 402.

The enclosure component 404 may include one or more circuitries that may perform various functions of the tester 400. For example, the enclosure component 404 may include control circuitry, digital signal processing circuitry, processor circuitry, multiplexing circuitry, test circuitry communication circuitry, display circuitry, memory circuitry, portal circuitry, modular circuitry and/or other circuitries that may be installed in the tester 400. The fault diagnostic module 324 may determine a faulty modular component 402 during a diagnostic test. The user may take the faulty modular component 402 out of the tester 400 and install a new modular component 402. Thus, the tester 400 may not need to be shipped back to the suppliers or manufacturers for repair.

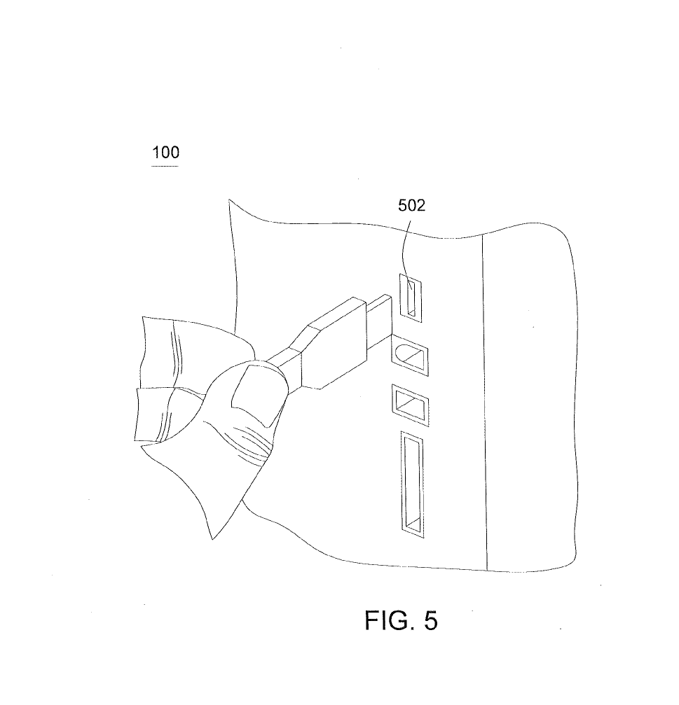

Referring to FIG. 5, in some embodiments of the alternator and starter tester, network connectivity may be used to track tests based on part number, employee and location in order to improve and enforce warranty reduction programs. The large-scale communication network ports can be constructed and arranged to receive an information relay device, such as an Ethernet wired module and/or an Ethernet wireless module. The Ethernet modules communicate at data rates of 10 Mbps (10Base-T Ethernet), 100 Mbps (Fast Ethernet), 1000 Mbps (Gigabit Ethernet) and other data rates. The information relayed can include data from the result of an alternator or starter test, the part's warranty information, the part type, the part make and model, previous tests, updates, diagnostic or operating parameters of the alternator and starter tester, maintenance data of the alternator and starter tester, and any other data required by the operator.

Referring to FIG. 5, in some embodiments, peripheral module ports 502 may be used to communicate to various peripheral devices such as a mouse, a keyboard, or a printer as well as to receive updates and/or downloads from a connected device such as a laptop or personal computer. The peripheral module ports 502 may be a USB module having ports for a host connection and a function connection. The USB module may communicate as USB 1.1 or USB 2.0, 3.0 or other data rates. The host connection may accommodate a mouse, a keyboard, or a printer. The function connection may accommodate a laptop or personal computer.

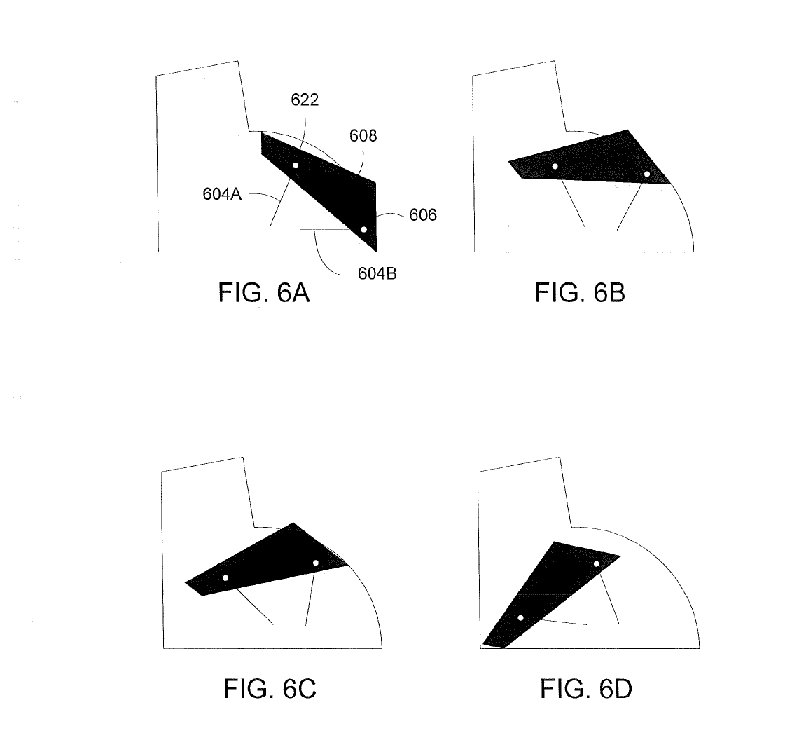

FIG. 6A-D illustrate an alternator and starter motor tester 600 having a four link protective door according to another embodiment of the present invention. FIGS. 6A-D illustrate the protective door cover 622 at various positions. For example, FIG. 6A illustrates that the protective door cover 622 in the closed position. FIG. 6B illustrates that the protective door cover 622 in the half opened position. FIG. 6C illustrates that the protective door cover 622 in the three-quarter opened position. Finally, FIG. 6D illustrates that the protective door cover 622 in the fully opened position. As discussed above, the protective door cover 622 may enclose moving parts and tested components during tests. The protective door cover 622 also conceals various testing components (e.g., the belt tensioning arrangement, the alternator mounting arrangement, the starter motor holder arrangement) and tested components, such as an alternator or starter motor from the user.

In the closed position, the protective door cover 622 prevents the likelihood of hands getting caught in moving parts or projectiles from being thrown towards customers or retail personnel. In another embodiment, the protective door cover 622 has a door interlock switch (not shown) to disable tests while the protective door cover 622 is open. In still another embodiment, the protective cover includes a viewing window so that the operator can observe the tested components during the tests. The protective door cover 622 may be coupled to the tester 600 via a plurality of links 604. In an exemplary embodiment, the protective door cover 622 may be coupled to the tester 600 via a first link 604A and a second link 604B. The first link 604A and the second link 604B may allow the protective door cover 622 to have a plurality of pivot points and thus a greater freedom of movement during opening and closing of the protective door cover 622. The greater freedom of movement may allow the tester 600 to safely test a larger alternator and starter motor.

The plurality of links 604A-B may be composed of various materials. For example, the plurality of links 604 may be composed of metal material, plastic material, and/or other materials have sufficient rigidity to support the protective door cover 622. In an exemplary embodiment, the plurality of links 604A-B may have the same length that may allow the protective door cover 622 to swing between the open position and the closed position. In another exemplary embodiment, the plurality of links 604A-B may have different lengths that may allow the protective door cover 622 to swing between the open position and the closed position. In other exemplary embodiments, the plurality of links 604A-B may be telescopic that may extend or retract to allow the protective door cover 622 a greater freedom to move between the closed position and the open position.

The protective door cover 622 may comprise a shape that may accommodate larger tested components (e.g., alternator and starter motor). In an exemplary embodiment, the protective door cover 622 may comprise a first surface 606 and a second surface 608. The first surface 606 and the second surface 608 may form a predetermined angle. In an exemplary embodiment, the first surface 606 and the second surface 608 may form an approximately 90° angle. The first surface 606 and the second surface 608 may provide a greater clearance and increase a volume of the tester 600 in order to safely test larger components (e.g., alternators and starter motor).

As discussed above, the protective door cover 622 may be coupled to the tester 600 via the plurality of links 604. In other exemplary embodiments, the protective door cover 622 may be coupled to the tester 600 via a groove (not shown). For example, the protective door cover 622 may slide within the groove between the closed position and the open position. It may be appreciated by one of skilled in the art that other methods of attachment of the protective door cover 622 to the tester 600 may be possible.

The many features and advantages of the present disclosure are apparent from the detailed specification, and thus, it is intended by the appended claims to cover all such features and advantages of the present disclosure, which fall within the true spirit, and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

What is claimed is:

1. A diagnostic tool for testing a performance of a component of a vehicle, comprising:
a processor configured to process test information from an alternator of the vehicle and control and activate the alternator of the vehicle having identification information to be tested;
a memory configured to store the test information of the alternator and software that operates the diagnostic tool; and
a removable modular component comprising an operational circuitry that allows for the diagnostic tool to operate, wherein the removable modular component is replaced based on a determination that the operational circuitry is faulty, wherein the memory and the removable modular component are in communication with the processor.

2. The diagnostic tool of claim 1, wherein said processor is also configured to control and activate a starter motor of the vehicle and process starter motor information.

3. The diagnostic tool of claim 1, wherein the operational circuitry comprises at least one of the following: a control circuitry, a digital signal processing circuitry, a processor circuitry, a multiplexing circuitry, a test circuitry, a communication circuitry, a display circuitry, a memory circuitry, a portal circuitry and a modular circuitry.

4. The diagnostic tool of claim 1, further comprising a fault diagnostic module configured to perform a diagnostic test in order to determine whether the operational circuitry is faulty.

5. The diagnostic tool of claim 1, wherein the removable modular component further comprises a plurality of pins that provide power to the modular component and a ground connection to discharge the electrostatic charges accumulated on the removable modular component.

6. The diagnostic tool of claim 1, further comprising a protective cover having a first link and a second link to provide a plurality of pivot points for the protective cover.

7. A diagnostic tool for testing a performance of a component of a vehicle, comprising:
a processor configured to process test information from a starter motor of the vehicle and control and activate the starter motor of the vehicle having identification information to be tested;
a memory configured to store the test information of the starter motor and software that operates the diagnostic tool; and
a removable modular component comprising an operational circuitry that allows for the diagnostic tool to operate, wherein the removable modular component is replaced based on a determination that the operational circuitry is faulty, wherein the memory and the removable modular component are in communication with the processor.

8. The diagnostic tool of claim 7, wherein said processor is also configured to control and activate an alternator of the vehicle and process alternator information.

9. The diagnostic tool of claim 7, wherein the operational circuitry comprises at least one of the following: a control circuitry, a digital signal processing circuitry, a processor circuitry, a multiplexing circuitry, a test circuitry, a communication circuitry, a display circuitry, a memory circuitry, a portal circuitry and a modular circuitry.

10. The diagnostic tool of claim 7, further comprising a fault diagnostic module configured to perform a diagnostic test in order to determine whether the operational circuitry is faulty.

11. The diagnostic tool of claim 7, wherein the removable modular component further comprises a plurality of pins that provide power to the modular component and a ground connection to discharge the electrostatic charges accumulated on the removable modular component.

12. The diagnostic tool of claim 7, further comprising a protective cover having a first link and a second link to provide a plurality of pivot points for the protective cover.

13. A method of testing of a component of a vehicle, comprising the steps of:
activating, via a processor of a diagnostic tool, an alternator component to generate test information;
processing, via the processor of the diagnostic tool, the test information from the alternator component of the vehicle;
receiving the test information associated with the alternator component of the vehicle via test leads;
performing, via the processor of the diagnostic tool, a diagnostic test on the alternator component;
determining, via the processor of the diagnostic tool, whether a removable module component that comprises an operation circuitry is faulty and needs to be replaced based at least in part on a determination that the removable module component is faulty.

14. The method according to claim 13, further comprising the steps of:
activating, via the processor of the diagnostic tool, a starter motor to generate test information; and
performing, via the processor of the diagnostic tool, a diagnostic test on the starter motor.

15. The method according to claim 13, further comprising performing a diagnostic test in order to determine whether the operational circuitry is faulty.

16. A method of testing of a component of a vehicle, comprising the steps of:
activating, via a processor of a diagnostic tool, a starter motor to generate test information;
processing, via the processor of the diagnostic tool, the test information from the starter motor of the vehicle;
receiving the test information associated with the starter motor of the vehicle via test leads;
performing, via the processor of the diagnostic tool, a diagnostic test on the starter motor;
determining, via the processor of the diagnostic tool, whether a removable module component that comprises an operation circuitry is faulty and needs to be replaced based at least in part on a determination that the removable module component is faulty.

17. The method according to claim 16, further comprising the steps of:
activating, via the processor of the diagnostic tool, an alternator component to generate test information; and
performing, via the processor of the diagnostic tool, a diagnostic test on the alternator component.

18. The method according to claim 16, further comprising performing a diagnostic test in order to determine whether the operational circuitry is faulty.

19. The method according to claim 16, wherein the operation circuitry comprises at least one of the following: a control circuitry, a digital signal processing circuitry, a processor circuitry, a multiplexing circuitry, a test circuitry, a communication circuitry, a display circuitry, a memory circuitry, a portal circuitry and a modular circuitry.

20. A diagnostic tool for testing a performance of a component of a vehicle, comprising:
means for processing test information from an alternator or a starter motor of the vehicle and control and activate the alternator or the starter motor of the vehicle having identification information to be tested;
means for storing the test information of the alternator or the starter motor and software that operates the diagnostic tool; and
a removable modular component comprising an operational circuitry that allows for the diagnostic tool to operate, wherein the removable module component is replaced based on a determination that the operational circuitry is faulty, wherein the means for storing and the removable modular component are in communication with the means for processing.
